(19) United States
(12) Patent Application Publication
(10) Pub. No.: US 2026/0000117 A1
(43) Pub. Date: Jan. 1, 2026

(54) ELECTRONIC ATOMIZATION DEVICE AND ATOMIZATION CORE THEREOF

(71) Applicant: Smoore International Holdings Limited, George Town (KY)

(72) Inventor: Xiaoping LI, Shenzhen (CN)

(73) Assignee: Smoore International Holdings Limited, George Town (KY)

(21) Appl. No.: 19/319,853

(22) Filed: Sep. 5, 2025

Related U.S. Application Data
(63) Continuation of application No. PCT/CN2024/078632, filed on Feb. 26, 2024.

(30) Foreign Application Priority Data
Mar. 6, 2023 (CN) 202310208562.4

(51) Int. Cl. A24F 40/44; A24F 40/10; A24F 40/46; A24F 40/485; H05B 3/03

(52) U.S. Cl. CPC A24F 40/44; A24F 40/10; A24F 40/46; A24F 40/485; H05B 3/03

(57) ABSTRACT

An atomization core includes a porous base. The porous base includes a first surface, a second surface. The second surface is arranged opposite to the first surface. A thermally conductive layer is between the first surface and the second surface. The thermally conductive layer porosity is different than other parts of the porous base porosity. The atomization core includes a heating element is arranged on the first surface.

### RELATED APPLICATION

The present application is a continuation of International Patent Application No. PCT/CN2024/078632, filed on Feb. 26, 2024, which claims priority to Chinese Patent Application No. 202310208562.4, filed on Mar. 6, 2023. The entire disclosure of the prior applications are hereby incorporated by reference.

### TECHNICAL FIELD

The present disclosure relates to the field of atomization, including to an electronic atomization device and an atomization core thereof.

### BACKGROUND OF THE DISCLOSURE

An electronic atomization device in the related art generally includes an atomization core. The atomization core is configured to heat and atomize a liquid substrate to generate aerosols when electrified. The atomization core generally includes a porous body and a heating element arranged on the porous body. The porous body may be made of a high-temperature-resistant material, such as ceramic. The heating element may generally be a metal heating film, a metal mesh, a metal wire, or the like. The porous body of the atomization core is prone to local insufficient liquid supply, which leads to a local high temperature and then carbon deposition, affecting a service life. Consequently, successive aerosols have different tastes, affecting consumer experience.

### SUMMARY

A technical problem to be solved in the present disclosure is to provide an improved electronic atomization device and an atomization core thereof.

A technical solution adopted in the present disclosure to resolve the technical problem is as follows: An atomization core is constructed, which includes a porous base and a heating element. The porous base includes a first surface, a second surface. The second surface is arranged opposite to the first surface. A thermally conductive layer is between the first surface and the second surface. The thermally conductive layer porosity is different than other parts of the porous base porosity. The heating element is arranged on the first surface.

In an aspect, the porosity of the thermally conductive layer is in a range of 80% to 99%;
and/or
the porosity of the porous base is greater than or equal to 30% and less than 80%.

In an aspect, the thermal conductivity of the thermally conductive layer is greater than the thermal conductivity of the porous base.

In an aspect, the average pore diameter of the pores in the thermally conductive layer is greater than the average pore diameter of the pores in the porous base.

In an aspect, the thermally conductive layer is at least one of porous metal, porous ceramic, or porous glass.

In an aspect, the ratio of the total pore volume of the thermally conductive layer to the total pore volume of the portion of the porous base located between the first surface and the thermally conductive layer is in a range of 2:1 to 10:1.

In an aspect, the distance from the first surface to the thermally conductive layer is in a range of 0.2 mm to 5 mm.

In an aspect, at least one liquid guiding through hole is provided in the porous base, through which the first surface and the thermally conductive layer are in communication.

In an aspect, the caliber of the liquid guiding through hole is in a range of 0.05 mm to 2 mm.

In an aspect, the cross-sectional area of the liquid guiding through hole is designed to gradually increase in the direction toward the first surface.

In an aspect, a plurality of liquid guiding through holes are provided, the plurality of the liquid guiding through holes are provided at intervals, and the spacing between two adjacent liquid guiding through holes is in a range of 0.2 mm to 2 mm.

In an aspect, the porous base at least includes a first portion connected to the second surface and a second portion connected to the first surface.

The first portion and the second portion are the same; or at least one of the porosity and/or the average pore diameter of the first portion and the second portion is different.

The present disclosure further constructs an electronic atomization device, including the atomization core according to the present disclosure.

The implementation of the electronic atomization device and the atomization core thereof according to the present disclosure has the following beneficial effects: In the atomization core, the thermally conductive layer having the porous structure and the porosity greater than the porosity of the porous base is arranged between the second surface and the first surface of the porous base, which not only enables the porous body to store more liquid substrates and guide the liquid substrates more rapidly to the first surface, but also enables preheating of a high-viscosity liquid substrate to ensure fluidity of the liquid substrate, thereby further improving liquid supply, and preventing local insufficient liquid supply and carbon deposition as a result of a local high temperature, prolonging a service life, improving consistency in tastes, and enhancing user experience.

### BRIEF DESCRIPTION OF THE DRAWINGS

The present disclosure is further described below with reference to the drawings and examples. In the drawings:

FIG. 1 is a schematic structural diagram of an electronic atomization device according to an aspect of the present disclosure.

FIG. 2 is a schematic structural diagram of an atomization core in the electronic atomization device shown in FIG. 1.

FIG. 3 is a cross-sectional view of the atomization core shown in FIG. 2.

FIG. 4 is a schematic structural diagram of a porous body of the atomization core shown in FIG. 3.

FIG. 5 is a cross-sectional view of an atomization core in an electronic atomization device according to an aspect of the present disclosure.

FIG. 6 is a cross-sectional view of an atomization core in an electronic atomization device according to an aspect of the present disclosure.

FIG. 7 is a cross-sectional view of an atomization core in an electronic atomization device according to an aspect of the present disclosure.

FIG. 8 is a cross-sectional view of an atomization core in an electronic atomization device according to an aspect of the present disclosure.

FIG. 9 is a cross-sectional view of an atomization core in an electronic atomization device according to an aspect of the present disclosure.

FIG. 10 is a cross-sectional view of an atomization core in an electronic atomization device according to an aspect of the present disclosure.

### DETAILED DESCRIPTION

To enable clearer understanding of technical features, objectives, and effects of the present disclosure, specific implementations of the present disclosure are described in detail with reference to drawings. In the following description, it should be understood that orientation or position relationships indicated by “up”, “down”, “inside”, “outside”, and the like are constructed and operated in specific directions based on the orientation or position relationships shown in the drawings, and are merely used for ease of describing the technical solutions, rather than indicating that devices or elements need to have a specific orientation. Therefore, the terms should not be construed as a limitation on the present disclosure.

It should be further noted that, unless explicitly stated and defined otherwise, terms such as “first”, “second”, and “third” are merely used for ease of describing the technical solutions, and should not be understood as indicating or implying relative importance or implicitly indicating a number of indicated technical features. Therefore, features defined by “first”, “second”, “third”, and the like may explicitly or implicitly include one or more such features. A person of ordinary skill in the art may understand the specific meanings of the foregoing terms in the present disclosure based on specific situations.

In the following descriptions, for description rather than limitation, specific details such as particular system structures and technologies are provided to facilitate thorough understanding of the embodiments of the present disclosure. However, it is clear to a person skilled in the art that the present disclosure may be further implemented in other embodiments without these specific details. In another case, detailed descriptions of well-known systems, devices, circuits, and methods are omitted to avoid unnecessary details that hinder the description of the present disclosure.

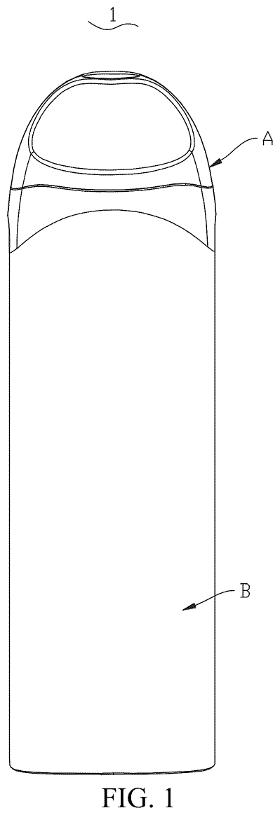

FIG. 1 shows an electronic atomization device 1 according to a first embodiment of the present disclosure. The electronic atomization device 1 is configured to heat a liquid substrate so as to generate aerosols for a user to inhale. In an aspect, the liquid substrate may be an aerosol generating substrate in a liquid form. The electronic atomization device 1 has advantages of a long service life, consistent tastes, and high user experience.

In this embodiment, the electronic atomization device 1 may include an atomizer A and a power supply assembly B. The atomizer A may atomize the liquid substrate to generate aerosols in an electrified state. The power supply assembly B is mechanically and/or electrically connected to the atomizer A, and is configured to supply power to the atomizer A. In this embodiment, the atomizer A may include a housing, an atomization base, and an atomization core 100. A liquid storage cavity is formed on the inner side of the housing for storing the liquid substrate. The atomization base is mounted in the housing, is configured to accommodate the atomization core 100, and has an atomization cavity formed therein. An air outlet tube in communication with the atomization cavity is arranged in the housing. The atomization core 100 may generate aerosols by atomizing the liquid substrate delivered from the liquid storage cavity, and the aerosols may be outputted through the air outlet tube for a user to inhale.

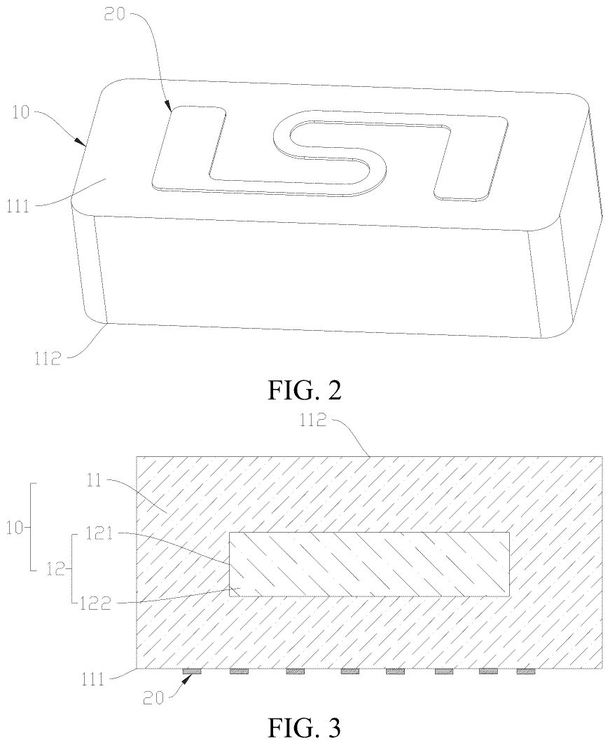

As shown in FIG. 2 and FIG. 3, the atomization core 100 in this embodiment includes a porous body 10 and a heating element 20. The porous body 10 is configured to deliver the liquid substrate from the liquid storage cavity to the heating element 20 by a capillary action. The heating element 20 is arranged on the porous body 10, and is configured to generate a high temperature after being electrified, to heat the liquid substrate to generate aerosols.

As shown in FIG. 4, in this embodiment, the porous body 10 may be substantially in a shape of a plate, and specifically, may be substantially in a shape of a rectangular plate. The porous body 10 includes a porous base 11. The porous base 11 is substantially in a shape of a plate. It may be understood that, in some other embodiments, the porous base 11 is not limited to the shape of a plate, and may be in a shape of a column or other shapes. In this embodiment, the porous base 11 may be porous ceramic. Certainly, it may be understood that, in some other embodiments, the porous base 11 is not limited to porous ceramic, and may be porous metal or porous glass. In this embodiment, the porosity of the porous base 11 may be greater than or equal to 30% and less than 80%, so that the porous base can adsorb the liquid substrate and guide the liquid substrate to the heating element 20.

In this embodiment, the porous base 11 may include a first surface 111 and a second surface 112. The first surface 111 is configured to carry the heating element 20 to form an atomization surface. The second surface 112 is arranged opposite to the first surface 111. The second surface 112 forms a liquid absorbing surface, which is in liquid guiding connection with the liquid storage cavity and may absorb the liquid substrate in the liquid storage cavity through a capillary action. In this embodiment, both the first surface 111 and the second surface 112 are planar surfaces. In some other embodiments, the first surface 111 and the second surface 112 may be curved surfaces or uneven surfaces.

In this embodiment, the porous body 10 further includes a thermally conductive layer 12 having a porous structure. The thermally conductive layer 12 is arranged in the porous base 11. Specifically, the thermally conductive layer 12 is arranged between the second surface 112 and the first surface 111, is arranged in the middle portion of the porous base 11, and is in fluid communication with both the first surface 111 and the second surface 112, and can transfer heat with both the first surface 111 and the second surface 112. In this embodiment, the distance from the first surface 111 to the thermally conductive layer 12 may be in a range of 0.2 mm to 5 mm. Preferably, the distance from the first surface 111 to the thermally conductive layer 12 may be in a range of 0.3 mm to 2 mm. In other words, the distance from the first surface 111 to the lowest position of the thermally conductive layer 12 may be in a range of 0.3 mm to 2 mm, which can ensure the liquid guiding effect of the thermally conductive layer 12 while ensuring the overall strength of the porous body 10. In this embodiment, the distance from the thermally conductive layer 12 to the first surface 111 may be equal to the distance from the thermally conductive layer 12 to the second surface 112, that is, the distance from the top surface of the thermally conductive layer 12 to the first surface 111 may be equal to the distance from the bottom surface of the thermally conductive layer 12 to the second surface 112. It may be understood that, in some other embodiments, the distance from the thermally conductive layer 12 to the first surface 111 may be less than or greater than the distance to the second surface 112, that is, the distance from the top surface of the thermally conductive layer 12 to the first surface 111 may be less than or greater than the distance from the bottom surface of the thermally conductive layer 12 to the second surface 112.

In this embodiment, the porosity of the thermally conductive layer 12 is greater than the porosity of the porous base, and the thermally conductive layer may be in fluid communication with the first surface 111 and the second surface 112. The thermal conductivity of the thermally conductive layer 12 is greater than the thermal conductivity of the porous base 11, that is, the thermally conductive layer 12 not only may absorb the liquid substrate delivered from the second surface 112 through the capillary action and guide the liquid substrate to the first surface 111, but also may be configured to preheat a high-viscosity liquid substrate, so as to reduce the viscosity of the high-viscosity liquid substrate, and improve the fluidity of the high-viscosity liquid substrate. It should be noted that the preheating includes two aspects: one is to preheat the liquid substrate inside the thermally conductive layer 12, to reduce the viscosity of the liquid substrate; and the other is to transfer heat to the second surface 112 and rapidly preheat the liquid substrate on the second surface 112, to enhance the overall liquid guiding smoothness, and alleviate a problem about liquid supply of the porous body 10, thereby preventing local insufficient liquid supply and carbon deposition as a result of a local high temperature, prolonging a service life, improving consistency in tastes, and enhancing user experience. In this embodiment, the porosity of the thermally conductive layer is in a range of 80% to 99%.

In this embodiment, a cavity 121 may be provided in the porous base 11, which is configured to filled with a first functional porous body 122 to form the thermally conductive layer 12. The cavity 121 is located between the first surface 111 and the second surface 112, and is in fluid communication with the first surface 111 and the second surface 112. In this embodiment, the cavity 121 may be a cavity in a shape of a cuboid. Certainly, it may be understood that, in some other embodiments, the cavity 121 is not limited to the shape of a cuboid, and may be in a shape of a cylinder or other shapes. In some other embodiments, the cavity 121 may be in an irregular shape. The first functional porous body 122 is arranged in the porous base 11. Specifically, the first functional porous body 122 is filled in the cavity 121. The shape and the size of the first functional porous body may match the shape and size of the cavity 121. Specifically, the first functional porous body 122 may be in a shape of a cuboid, and the height, length, and width of the first functional porous body may be equivalent to the height, length, and width of the cavity 121. It may be understood that, in some other embodiments, the cavity 121 may be omitted, and the first functional porous body 122 may be integrally formed with the porous base 11 through sintering.

The porosity of the first functional porous body 122 is greater than the porosity of the porous base 11. In this embodiment, the porosity of the first functional porous body 122 may be selectively in a range of 80% to 95%. In this embodiment, the thermally conductive layer 12 may be porous metal, for example, may be foam metal, foam copper, or foam nickel. Specifically, the first functional porous body 122 may be porous metal, for example, may be foam metal, foam copper, or foam nickel. Certainly, it may be understood that, in some other embodiments, the thermally conductive layer 12 is not limited to porous metal, and may be porous ceramic, such as alumina or silicon carbide. It should be noted that in this disclosure, factors affecting the thermal conductivities of the thermally conductive layer 12 and the porous base mainly include a material type and an internal pore structure. Generally, a porosity and a thermal conductivity are inversely correlated. To be specific, as for a same material, a higher porosity indicates a lower thermal conductivity. Similarly, as for same structure, an intrinsic thermal conductivity of a material defines an overall thermal conductivity. In an aspect of this disclosure, the porosity of the thermally conductive layer 12 is greater than the porosity of the porous base. Therefore, in order to ensure that the overall thermal conductivity of the thermally conductive layer is greater than the thermal conductivity of the porous base, the material of the thermally conductive layer is preferably a metal material, namely, the porous metal mentioned in the above implementations, such as foam metal, foam copper, or foam nickel.

In this embodiment, the average pore diameter of the pores in the thermally conductive layer 12 may be greater than the average pore diameter of the pores in the porous base 11, that is, the average pore diameter of the pores in the first functional porous body 122 may be greater than the average pore diameter of the pores in the porous base 11. In an aspect, the average pore diameter of the porous base 11 may be in a range of 10 μm to 35 μm. Preferably, the average pore diameter of the porous base 11 is in a range of 10 μm to 20 μm. Because the pore diameter of the porous base 11 is less than the pore diameter of the first functional porous body 122, a liquid locking effect can be improved, thereby preventing a leakage of the liquid substrate from the porous body 10 when the electronic atomization device 1 is idle. The configuration in which the average pore diameter of the pores in the first functional porous body 122 is greater than the average pore diameter of the pores in the porous base 11 can improve the liquid guiding effect, improve liquid supply, and avoid insufficient liquid supply. In some other embodiments, the porosity of the first functional porous body 122 may be increased by increasing the number of pores in the first functional porous body 122.

In this embodiment, the ratio of the total pore volume of the thermally conductive layer 12 to the total pore volume of the portion of the porous base 11 located between the first surface 111 and the thermally conductive layer 12 is in a range of 2:1 to 1:10. The ratio between the total pore volumes may define the upper limit of the liquid supply effect. For example, the single atomization amount is 6 mg, the liquid storage amount of the portion of the porous base 11 located between the first surface 111 and the thermally conductive layer 12 is 4 mg, and the liquid storage amount of the thermally conductive layer 12 is 2 mg, that is, the ratio is approximately 1:2.

In this embodiment, the heating element 20 may be a heating film, which may be arranged on the first surface 111 of the porous body 11 through silk screen printing. Certainly, it may be understood that, in some other embodiments, the heating element 20 is not limited to the heating film and may be a heating sheet or a heating wire. The heating element 20 is not limited to being arranged on the first surface of the porous body 11 through silk screen printing, and may be integrally formed with the porous body 11 through sintering or the like. In an aspect, the heating element 20 may be a silk screen-printed thick film, a metal thin film, or the like. In an aspect, the heating film may further have a porous structure, such as be a porous metal film.

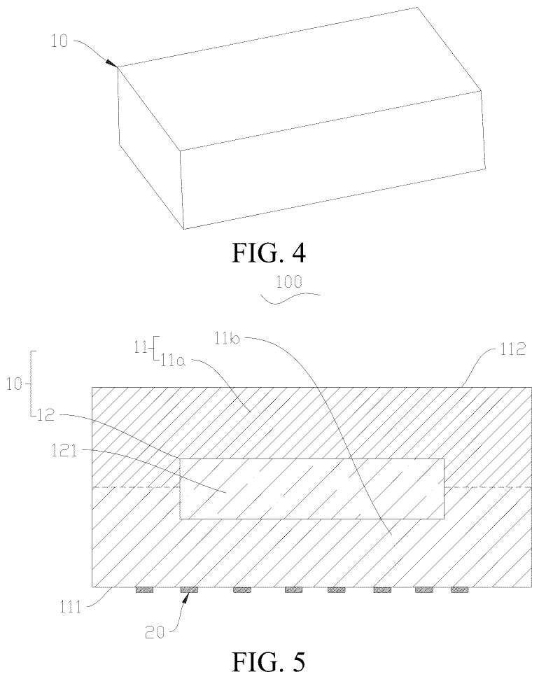

FIG. 5 shows an atomization core in an electronic atomization device according to a second embodiment of the present disclosure. A difference from the first embodiment lies in that the porous base 11 includes a first portion 11a and a second portion 11b. The first portion 11a is connected to the second surface 112. The first portion 11a is located between the cavity 121 and the second surface 112. The second portion 11b is connected to the first surface 111. The second portion 11b is located between the cavity 121 and the first surface 111. The first portion 11a, the functional layer 12, and the second portion 11b may be formed as an integrated structure through first fabricating cast films or blank bodies respectively corresponding to the portions, then stacking, and then sintering. In this embodiment, the first portion 11a and the second portion 11b are different. Specifically, at least one of the porosities, the pore diameters, the thermal conductivities, or the materials may be different. Certainly, it may be understood that, in some other embodiments, the first portion 11a and the second portion 11b may be the same, that is, the porosities, the pore diameters, the thermal conductivities, the materials, and the like of the first portion 11a and the second portion 11b are identical. When the first portion 11a and the second portion 11b are the same, corresponding blank bodies may be directly integrally fabricated and then sintered.

In this embodiment, the porosity of the second portion 11b may be greater than the porosity of the first portion 11a. Specifically, the average pore diameter of the pores in the second portion 11b is greater than the average pore diameter of the pores in the first portion 11a. That is, the second portion 11b can guide liquids rapidly and has a larger liquid storage amount, thereby rapidly guiding the liquid substrate in the thermally conductive layer 12 to the first surface 111. The first portion 11a has a liquid locking function to prevent a liquid leakage, especially preventing a leakage of a low-viscosity liquid substrate. It may be understood that, in some other embodiments, the number of pores in the second portion 11b may be greater than the number of pores in the first portion 11a, or the average pore diameter of the pores in the second portion 11b may be greater than the average pore diameter of the pores in the first portion 11a, or the number of pores in the second portion 11b may be greater than the number of pores in the first portion 11a.

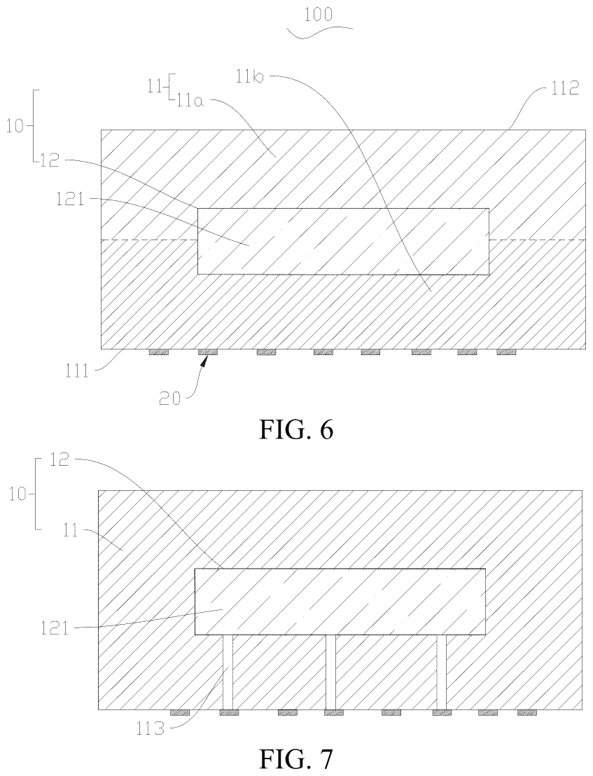

FIG. 6 shows an atomization core in an electronic atomization device according to a third embodiment of the present disclosure. A difference from the first embodiment lies in that the pore porosity of the second portion 11b is less than the pore porosity of the first portion 11a, and the average pore diameter of the second portion 11b is less than the average pore diameter of the first portion 11a, so as to improve the liquid guiding rate of the high-viscosity liquid substrate. After being preheated, the liquid substrate in the cavity 121 can be quickly guided to the atomization surface through the first portion 11a by means of a high capillary pressure, thus improving the liquid supply effect and avoiding dry heating.

FIG. 7 shows an atomization core in an electronic atomization device according to a fourth embodiment of the present disclosure. A difference from the first embodiment lies in that a liquid guiding through hole 113 is provided in the porous base 11. A plurality of the liquid guiding through holes 113 may be provided, and the plurality of the liquid guiding through holes 113 are provided at intervals. The spacing between two adjacent liquid guiding through holes 113 may be in a range of 0.2 mm to 2 mm. Specifically, in this embodiment, the spacing between two adjacent liquid guiding through holes 113 may be selectively in a range of 0.4 mm to 1 mm. The liquid guiding through hole 113 is provided between the thermally conductive layer 12 and the first surface 111 and is a straight through hole extending from the thermally conductive layer 12 to the first surface 111. Each liquid guiding through hole 113 may be configured to cause the first surface 111 and the thermally conductive layer 12 to be in communication. In this embodiment, the caliber of the liquid guiding through hole 113 is greater than the pore diameter of the porous base 11, and the cross-sectional area thereof is less than the cross-sectional area of the cavity 121. The liquid guiding through hole may adsorb the liquid substrate through a capillary action and then guide the liquid substrate to the first surface 111, while avoiding a leakage of a large amount of liquid substrates. In this embodiment, the caliber of the liquid guiding through hole 113 may be in a range of 0.05 mm to 2 mm. Specifically, in this embodiment, the caliber of the liquid guiding through hole 113 may be selectively in a range of 0.1 mm to 0.5 mm.

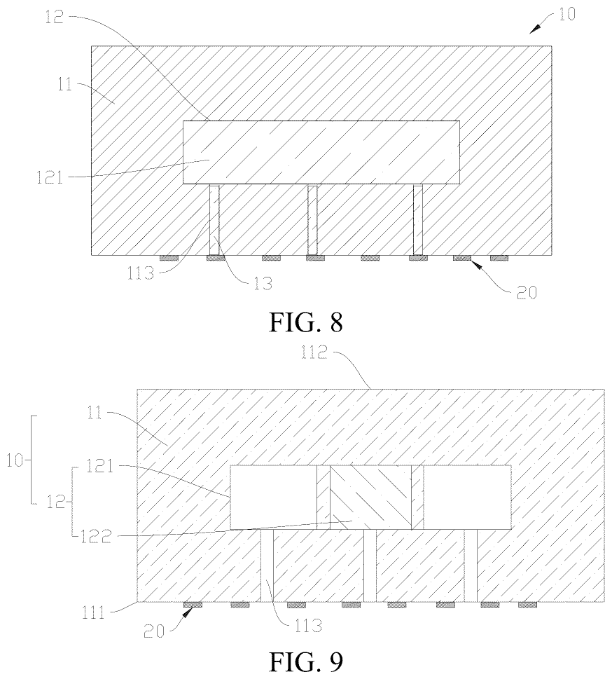

FIG. 8 shows an atomization core in an electronic atomization device according to a fifth embodiment of the present disclosure. A difference from the first embodiment lies in that a second functional porous body 13 is arranged in the liquid guiding through hole 113. The porosity of the second functional porous body 13 is greater than the porosity of the porous base 11. Specifically, the porosity of the second functional porous body 13 may be greater than 95%. That is, the porosity of the second functional porous body 13 may be greater than the porosity of the first functional porous body 122. It may be understood that, in some other embodiments, the porosity of the second functional porous body 13 is not limited to being greater than the porosity of the first functional porous body 122. Filling the second functional porous body 13 can ensure the liquid guiding effect and the liquid storage effect while improving the liquid locking effect, thereby preventing a liquid leakage. In this embodiment, the second functional porous body 13 may be in a shape of a column. Specifically, the cross-sectional shape and the size of the second functional porous body 13 may be equivalent to the cross-sectional shape and the size of the liquid guiding through hole 113. Specifically, the cross-sections of the liquid guiding through hole 113 and the second functional porous body 13 may be in a shape of a circle, and the diameters thereof may be set to be substantially equal. In an aspect, the second functional porous body 13 may be porous ceramic or cotton core.

FIG. 9 shows an atomization core in an electronic atomization device according to a sixth embodiment of the present disclosure. A difference from the first embodiment lies in that a plurality of the cavities 121 may be provided. The plurality of cavities 121 provided at intervals in the porous base 11, and two adjacent cavities 121 are in fluid communication. The first functional porous body 122 may be arranged in one of the cavities 121. Certainly, it may be understood that, in some other embodiments, the first functional porous body 122 may be arranged in the plurality of cavities 121. In this embodiment, the volumes of the cavities 121 may be the same. Certainly, it should be understood that, in some other embodiments, at least two cavities 121 of the plurality of cavities 121 may be configured with unequal volumes. For example, the cavities 121 may be cavities in a shape of a cuboid, and at least two cavities 121 of the cavities differ in at least one of parameters such as a height, a length, and/or a width. Specifically, the height of each cavity 121 may be different from that of another cavity 121, so that the volume of each cavity 121 differs from that of other cavity 121. In an aspect, at least two cavities 121 of the plurality of cavities 121 may be provided to be at different distances from the first surface 111. Specifically, the bottom surfaces of at least two cavities 121 of the plurality of cavities 121 may be at different distances from the first surface 111, so that the liquid substrates in different regions of the first surface 111 have different guiding rates. In other words, on the first surface 111, the liquid substrate in the region closer to the cavities 121 is guided more rapidly, and the liquid substrate in the region farther from the cavities 121 is guided more slowly. In this embodiment, the cavity 121 may be provided with the liquid guiding through hole 113 to guide the liquid substrate to the first surface 111, thereby ensuring an equalized temperature across the first surface 111.

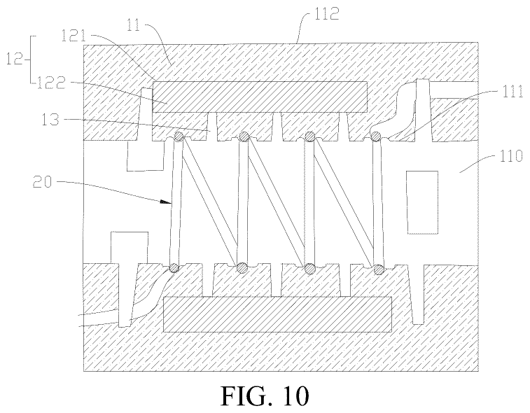

FIG. 10 shows an atomization core in an electronic atomization device according to a seventh embodiment of the present disclosure. A difference from the first embodiment lies in that the porous body 11 is overall in a shape of a column. A central through hole 110 is provided in the porous body 11. The central through hole 110 allows the heating element 20 to be mounted therein and can form an atomization channel. The first surface 111 is the inner wall surface of the porous body 11, and the second surface 112 is the outer wall surface of the porous body 11. The thermally conductive layer 12 and the central through hole 110 may be coaxially arranged substantially in an annular shape. In this embodiment, the heating element 20 may be a heating wire.

A liquid guiding through holes 113 are provided in the porous base 11. A plurality of sets of liquid guiding through holes 113 are provided. The plurality of sets of the liquid guiding through holes 113 are axially provided at intervals along the central through hole 110. Each set of liquid guiding through holes 113 include a plurality of liquid guiding through holes. The plurality of liquid guiding through holes 113 may be provided at intervals circumferentially along the central through hole 110. The spacing between two adjacent liquid guiding through holes 113 is in a range of 0.2 mm to 2 mm. Preferably, the spacing between the two liquid guiding through holes 113 is in a range of 0.4 mm to 1 mm. The caliber of each of the liquid guiding through holes 113 may be in a range of 0.05 mm to 2 mm. Optionally, in this embodiment, the caliber of each of the liquid guiding through holes 113 is in a range of 0.1 mm to 0.5 mm.

In this embodiment, the cross-sectional area of the liquid guiding through hole 113 may be designed to gradually increase in the direction toward the first surface 111, thereby increasing the liquid storage amount of the liquid guiding through hole 113. However, since the caliber of the liquid guiding through hole 113 meets the liquid locking demand through a capillary action, the liquid substrate can be prevented from leaking into the central through hole 110 from the liquid guiding through hole 113 and then leaking out through the central through hole 110. The liquid guiding through hole 113 may be in a shape of a taper. Certainly, it may be understood that, in some other embodiments, the liquid guiding through hole 113 is not limited to be taper shape, and may be in a shape of a frustum or a trumpet.

It may be understood that the foregoing embodiments describe only preferred implementations of the present disclosure specifically and in detail, but cannot be construed as a limitation to the patent scope of the present disclosure. It should be noted that, without departing from the concept of the present disclosure, a person of ordinary skill in the art may freely combine the foregoing technical features, and may further make variations and improvements, which shall fall within the protection scope of the present disclosure. Therefore, equivalent changes and modifications made according to the scope of the claims of the present disclosure shall fall within the scope of the claims of the present disclosure.

What is claimed is:

1. An atomization core comprising:
a porous base (11) including a first surface (111), a second surface (112) arranged opposite to the first surface (111), and a thermally conductive layer (12), between the first surface (111) and the second surface (112), wherein the thermally conductive layer (12) porosity is different than the porous base (11) porosity, and
a heating element (20) being arranged on the first surface (111).

2. The atomization core of claim 1, wherein the thermally conductive layer (12) porosity is in a range of 80% to 99%; or
the porous base (11) porosity is greater than or equal to 30% and less than 80%.

3. The atomization core of claim 1, wherein the thermally conductive layer (12) thermal conductivity is greater than the porous base (11) thermal conductivity.

4. The atomization core of claim 1, wherein an average pore diameter of the thermally conductive layer (12) is greater than an average pore diameter of the other parts of the porous base (11).

5. The atomization core of claim 1, wherein the thermally conductive layer (12) is at least one of porous metal, porous ceramic, or porous glass.

6. The atomization core of claim 1, wherein a ratio of a total pore volume of the thermally conductive layer (12) to a total pore volume of the other parts of the porous base (11) is in a range of 2:1 to 1:10.

7. The atomization core of claim 1, wherein the distance from the first surface (111) to the thermally conductive layer (12) is in a range of 0.2 mm to 5 mm.

8. The atomization core of claim 1, further comprising at least one liquid guiding through hole (113), wherein the first surface (111) and the thermally conductive layer (12) are channeled.

9. The atomization core of claim 8, wherein a diameter of the liquid guiding through hole (113) is in a range of 0.05 mm to 2 mm.

10. The atomization core of claim 8, wherein the liquid guiding through hole (113) is configured to gradually increase cross-sectional area in the direction toward the first surface (111).

11. The atomization core of claim 8, further comprising a plurality of liquid guiding through holes (113), and a spacing between two adjacent liquid guiding through holes (113) is in a range of 0.2 mm to 2 mm.

12. The atomization core of claim 1, further comprising:
the porous base (11) including a first portion (11a) being connected to the second surface (112) and a second portion (11b) being connected to the first surface (111), and the first portion (11a) and the second portion (11b) having same porosity; or
the first portion (11a) and the second portion (11b) having different porosity.

13. An electronic atomization device, comprising the atomization core (100) according to claim 1.
